(19) United States
(12) Patent Application Publication
(10) Pub. No.: US 2023/0067489 A1
(43) Pub. Date: Mar. 2, 2023

(54) SIGNAL PROCESSING DEVICE FOR EMERGENCY MONITORING

(71) Applicant: Hi.Q, Inc., Plano, TX (US)

(72) Inventor: Tom Schollmeyer, Plano, TX (US)

(21) Appl. No.: 17/892,488

(22) Filed: Aug. 22, 2022

Related U.S. Application Data
(60) Provisional application No. 63/237,002, filed on Aug. 25, 2021.

(51) Int. Cl. H04W 4/90; H04W 4/38; B64C 39/02

(52) U.S. Cl. CPC H04W 4/90; H04W 4/38; B64C 39/024; B64C 2201/127

(57) ABSTRACT

A signal processing device can determine a wireless sensor signature of an individual within a sensory environment of the signal processing device, the wireless sensor signature corresponding to reflected wireless signals from the individual. Based on reflected wireless signals from the individual, the signal processing device can detect an emergency event at an emergency location within the sensory environment. In response to detecting the emergency event, the signal processing device can transmit, over a wireless network, a deploy command to a drone that includes a camera, the deploy command indicating the emergency location and including an imaging command to capture live images of the emergency event.

### CROSS-REFERENCE TO RELATED APPLICATION

This application claims the benefit of priority to U.S. Provisional Application No. 63/237,002, filed on Aug. 25, 2021; which is hereby incorporated by reference in its entirety.

### BACKGROUND

At home safety and monitoring devices typically utilize a combination of imaging, audio detection, and user interaction methods in order to, for example, provide assistance, alerts, entertainment, and/or security to users. However, the use of such active monitoring devices represents a tradeoff between smart home benefits and in-home privacy. Wireless sensing and artificial intelligence technology have opened the door to new possibilities in more passive but effective home monitoring and security with limited impact on privacy.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 illustrates signal processing device implementing wireless signal monitoring for emergency events, in accordance with examples described herein;

FIG. 2 is a flow chart describing a method of wireless signal monitoring and emergency event detection, according to various examples;

FIG. 3 illustrates a computing device for communicating with the signal processing device, according to examples described herein; and

FIG. 4 is a block diagram that illustrates a computer system upon which examples described herein may be implemented.

### DETAILED DESCRIPTION

A signal processing device is provided herein that can determine a set of a wireless sensor signatures of an individual within a dwelling. In various implementations, the set of wireless sensor signatures can correspond to reflected wireless signals from the individual, which can indicate a relative height, body shape, limb shape, head shape, respiratory pattern, movement patterns, walking gait and/or style, and any other individual characteristics of the individual. The source of the wireless signals can be outputted by the signal processing device, or can comprise latent or stray signals originating from wireless signal sources, such as a Wi-Fi router, smartphones, smart home devices, personal computers, and the like. As provided herein, the signal processing device can implement wireless artificial intelligence technology to perform the processes described throughout the present disclosure. Implementing such techniques, the signal processing device can, based on reflected wireless signals from an individual, detect an emergency event at an emergency location within the dwelling (e.g., a household, office space, etc.) or in a sensory environment (e.g., an outdoor area). In response to detecting the emergency event, the signal processing device can transmit, over a wireless network, a deployment command to an indoor or local drone that includes a camera. In various example, the deployment command can comprise flight instructions indicating the emergency location and can include an imaging command to capture live images of the emergency event.

In various implementations, the signal processing device can initiate wireless communications with a third-party entity to provide the third-party entity with an indication of the emergency event. For example, the third-party entity can comprise an emergency contact of the individual or an emergency service (e.g., a 911 dispatcher and/or an ambulance service). In certain examples, the imaging command can an instruction to the drone to record or otherwise stream the live images of the emergency event. The signal processing device can receive a recording or live stream of the live images of the emergency event from the indoor drone over the wireless network and transmit the recording or live stream of the live images to the third-party entity via the wireless communications.

Examples described herein achieve a technical effect of utilizing granular wireless signal processing technology to detect emergency events in a sensory environment detectable by a signal processing device and the use of drone technology to provide on-demand imaging of emergency events. Since the drone is deployable to capture on-demand images, there is no need for continuous capture cameras or motion sensing cameras to capture video recordings of a particular space, which has resulted in privacy concerns among consumers.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions, and includes the implementation of machine learning and/or artificial intelligence to execute the processes described throughout the present disclosure. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

Signal Processing Device

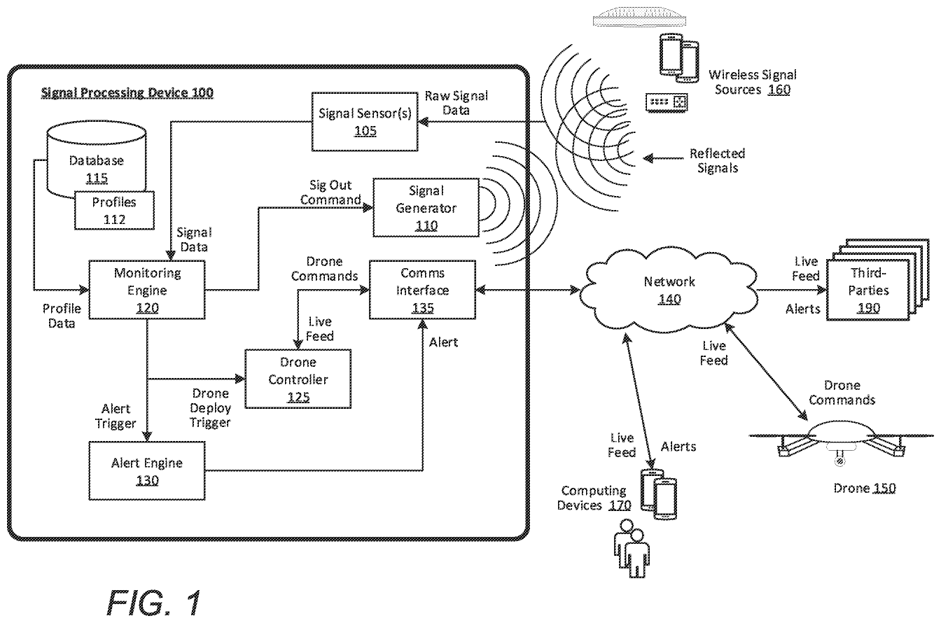

FIG. 1 illustrates signal processing device implementing wireless signal monitoring for emergency events, in accordance with examples described herein. In various implementations, the signal processing device 100 can include a set of one or more signal sensors 105 can detect wireless signals in a sensory environment (e.g., Wi-Fi signals, Bluetooth signals, etc.). The sensory environment can comprise any environment in which the signal processing device 100 can receive reflected wireless signals, such as in an indoor dwelling, office space, nursing home, health care facility, and the like. The sensory environment can further include an outdoor environment, such as a gathering area, porch, backyard area, exercise area, and the like. In various implementations, the set of signal sensors 105 can detect the raw signal data from external wireless signal sources 160, which can include routers, smart home devices, smartphones, and other computing devices. Additionally or alternatively, the signal processing device 100 can include a signal generator 110 that outputs wireless signals (e.g., via a signal output command from a monitoring engine 120 of the signal processing device 100), which can reflect throughout the sensory environment. The reflected signals may be received by the set of signal sensors 105 as raw signal data for processing by a monitoring engine 120 of the signal processing device 100.

It is contemplated that the granularity of wireless signal sensing technology allows for identifying individual characteristics and attributes of people. According to examples provided herein, the signal processing device 100 can include a database 115 comprising sensor profiles 112 of any number of individuals that may be expected to regularly visit or reside in the sensory environment. The sensor profiles 112 can include identifiers of each of the individuals, personal information, such as age and any health risk information, and the unique sensory characteristics of each of the individuals.

As described herein, the unique sensory characteristics correspond to the individual's height, body shape and characteristics (e.g., length, width, etc.), limb characteristics, head shape, and the like. Furthermore, given the highly granular and improving state of wireless sensing technology, the monitoring engine 120 can process the signal data from the set of signal sensors 105 to determine and authenticate the presence of a particular individual based on sensory profile information stored in the profile 112 of the individual, and determine current health-related attributes of the individual, such as respiratory attributes (e.g., respiratory rate and/or breathing abnormalities), any gait abnormalities in the individual's walking pattern (e.g., a limp or struggled gait pattern), and any other potential emergency events (e.g., a fall, a heart attack, unresponsiveness or lack of breathing, shortness of breath, and the like).

In various implementation, when the monitoring engine 120 identifies an individual within the sensory environment and detects an emergency event, the monitoring engine 120 can generate an alert trigger that can be processed by an alert engine 130 of the signal processing device 100. The alert engine 130 can determine information from the alert trigger, such as the individual's identity and/or the nature of the emergency event (e.g., a fall or respiratory abnormality) and transmit, over one or more networks 140, an alert to a third-party entity 190 using a communication interface 135 of the signal processing device 100. As described herein, the third-party entity 190 can comprise an emergency service, such as a 911 service or ambulance. Additionally, the third-party entity 190 can comprise a health care provider of the individual.

Additionally or alternatively, the alert engine 130 can transmit the alert to a computing device 170 of a contact of the individual, such as an emergency contact, a caretaker, a family member, and the like. The alert can indicate the emergency event and the identity of the individual, and can be transmitted via a messaging application, such as text or email. In variations, the alert may comprise a voice interactive phone call in which the signal processing device 100 utilizes voice output technology to indicate the nature of the emergency event, the identity of the individual, and an emergency location (e.g., the address of the individual.

In additional implementations, the monitoring engine 120 can transmit a drone deploy trigger to a drone controller 125 of the signal processing device 100. The drone controller 125 can process the drone deploy trigger to determine an emergency location of the emergency event and transmit drone commands to an indoor or otherwise local drone 150. Using the emergency location, the drone 150 can operate to fly to the emergency location using internal navigation methods (e.g., image processing, collision avoidance, localization mapping, etc.) and record live images of the emergency event (e.g., a live video feed), where the live images can include images of the individual.

In various examples, the live feed can be transmitted by the drone 150 to the signal processing device 100, recorded by the drone 150 and/or the signal processing device 100, transmitted directly from the drone 150 to a third-party entity 190 or computing device 170 of an emergency contact of the individual, and/or transmitted by the signal processing device 100 to the third-party entity 190 or computing device 170 of the emergency contact. In certain examples, a recording of the live images captured by the drone 150 can be stored by the signal processing device 100 and transmitted to the third-party entity 190 or emergency contact upon request. Thus, emergency services, health care providers, emergency contacts of the individual, and the like can be provided with real-time images of the emergency event and respond accordingly.

In still further implementations, the monitoring engine 120 can transmit a query to a computing device of the individual, or can include voice output and recognition technology that can speak a query that asks whether the individual is okay. Upon receiving a response (e.g., an input response on a computing device or a voice response from the individual), the monitoring engine 120 can be triggered to deploy the drone 150 and/or issue an alert trigger to the alert engine 130 if the individual is not okay, or can continue monitoring the individual if an affirmative response is received.

Methodology

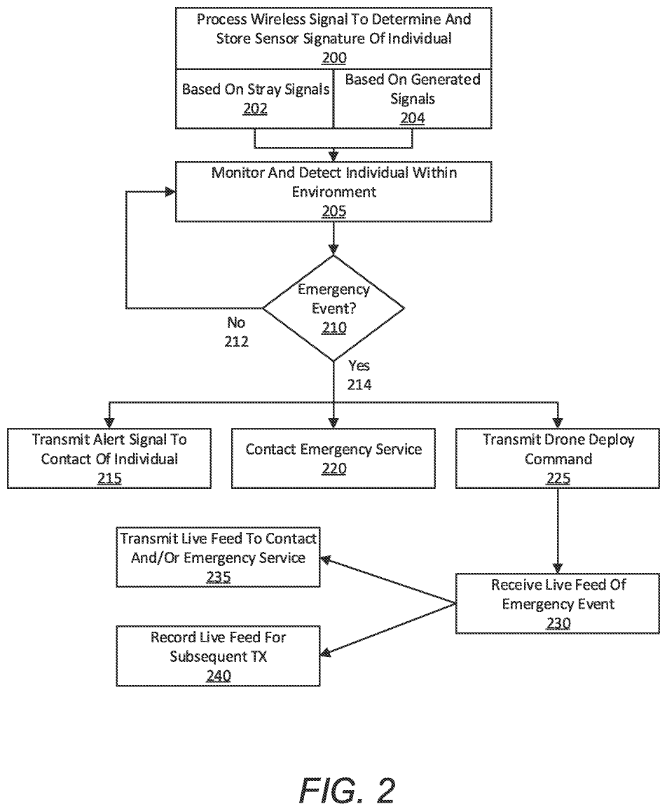

FIG. 2 is a flow chart describing a method of wireless signal monitoring and emergency event detection, according to various examples. In the below discussion of FIG. 2, reference may be made to reference characters corresponding to like features as shown and described with respect to FIG. 1. Furthermore, the steps described in connection with FIG. 2 may be performed by the signal processing device 100 described with respect to FIG. 1. Referring to FIG. 2, the signal processing device 100 can process wireless signals to determine and store the sensor signature of an individual within a sensory environment of the signal processing device 100 (200). The wireless signals can comprise latent or stray signals from other sources 160 (202), or can be based on generated signals from a signal generator 110 of the signal processing device 100 (204).

During monitoring, the signal processing device 100 can detect the individual within the environment at any given time (205). For each instance of detection, the signal processing device 100 can determine whether an emergency event is occurring (210). If not (212), then the signal processing device 100 can continue monitoring the individual within the environment accordingly (205). However, if an emergency event is detected (214), the signal processing device 100 can perform any combination of the following actions. In a first action, the signal processing device 100 can transmit an alert to a contact of the individual, such as a health care providers, a caretaker, or a family member (215). In a second action, the signal processing device 100 can contact an emergency service, such as a 911 service, an ambulance service, or a health care facility (220). In a third action, the signal processing device 100 can transmit a drone deploy command to a drone 150 proximate to the individual (e.g., housed in the same residence as the individual) (225).

As provided herein, the alert can comprise an identifier of the individual (e.g., a name), a location of the individual, and/or can indicate the nature of the emergency (e.g., shortness of breath detected, potential heart attack occurrence, a fall occurrence, and the like). As further provided herein, the drone 150 may be instructed to fly to an emergency location corresponding to the emergency event and record live images of the event. In various implementations, the signal processing device 100 can receive the live feed or recording of the emergency event (230). Upon receiving the live feed and/or recording, the signal processing device 100 can either transmit the live feed to a computing device of the emergency contact or emergency service (235). For example, the live feed may be patched to a computing device of an ambulance en route to the emergency location. Additionally or alternatively, the signal processing device 100 may record the live feed for subsequent transmission to any third-party entity.

Computing Device

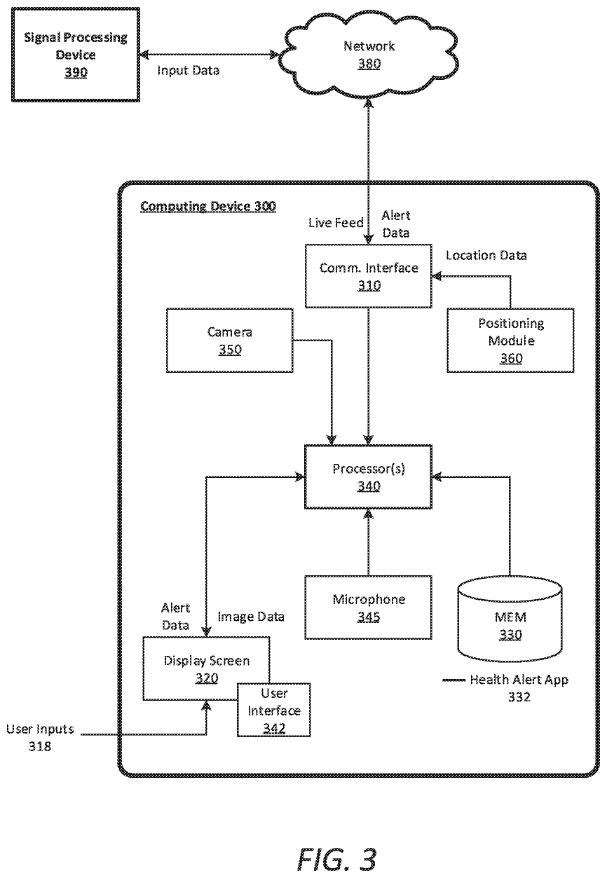

FIG. 3 illustrates a computing device 300 for communicating with the signal processing device 390, according to examples described herein. In many implementations, the computing device 300 can comprise a mobile computing device, such as a smartphone, tablet computer, laptop computer, personal computer, VR or AR headset device, and the like. In certain examples, the computing device 300 can include telephony features such as a microphone 345, a camera 350, and a communication interface 310 to communicate with the signal processing device 390 using any number of wireless communication protocols. The computing device 300 can further include a positioning module 360 (e.g., GPS) and/or an inertial measurement unit that includes one or more accelerometers, gyroscopes, or magnetometers.

In certain aspects, the computing device 300 can store a designated health alert application 332 in a local memory 330. The computing device 300 can further access one or more networks 380 via a web browser. In variations, the memory 330 can store additional applications executable by one or more processors 340 of the computing device 300, enabling access and interaction with one or more servers over the one or more networks 380.

Additionally, the computing device 300 can be operated by a user through execution of the health alert application 332. In various examples, the user can select the health alert application 332 via a user input 318 on the display screen 320, which can cause the application 332 to be executed by the processor 340. In response, an interactive user interface 342 can be generated on the display screen 320, which can display details of alerts, notifications, and/or a live feed of an emergency event.

As provided herein, the application 332 can enable a communication link over one or more networks 380 with the signal processing device 390, such as the signal processing device 100 shown and described with respect to FIG. 1. The processor 340 can generate user interface features 342 using image data received from the signal processing device 390 over the network 380. As provided herein, the image data can correspond to a recording or a live stream of an emergency event as recorded by a camera of a drone 150. Thus, upon the detection of an emergency event, alert data and/or the live feed captured by the drone 150 can be transmitted over the network 380 to the computing device 300, which can display the alert and/or live feed on the display screen 320 (e.g., via the executing health alert application 332).

Hardware Diagram

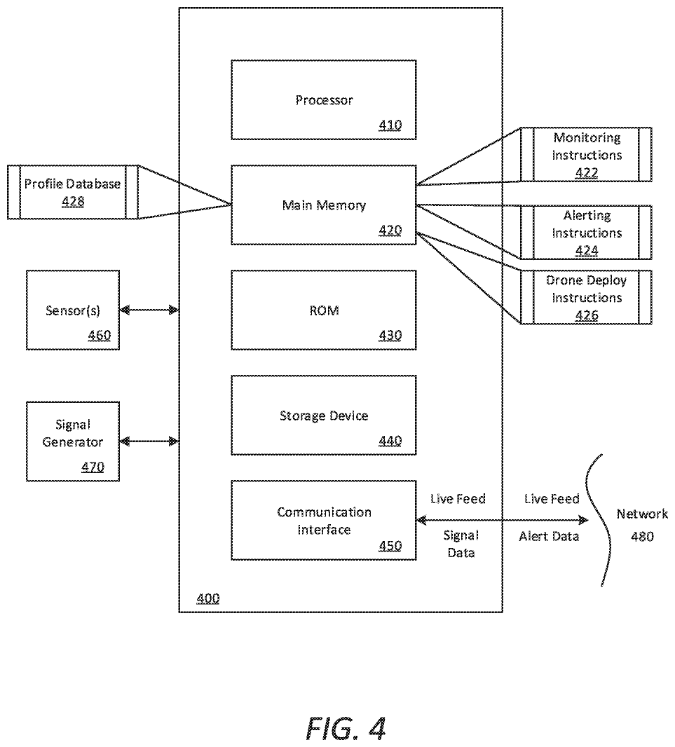

FIG. 4 is a block diagram that illustrates a computer system 400 upon which examples described herein may be implemented. A computer system 400 can be implemented on, for example, computer module, computer server, or a combination of computing device. For example, the computer system 400 may be implemented as part of a network-based service, such as described in FIGS. 1 through 3. In the context of FIG. 1, the signal processing device 100 may be implemented using a computer system 400 such as described by FIG. 4.

In one implementation, the computer system 400 includes processing resources 410, a main memory 420, a read-only memory (ROM) 430, a storage device 440, and a communication interface 450. The computer system 400 includes at least one processor 410 for processing information stored in the main memory 420, such as provided by a random-access memory (RAM) or other dynamic storage device, for storing information and instructions which are executable by the processor 410. The main memory 420 also may be used for storing temporary variables or other intermediate information during execution of instructions to be executed by the processor 410. The computer system 400 may also include the ROM 430 or other static storage device for storing static information and instructions for the processor 410. A storage device 440, such as a magnetic disk or optical disk, is provided for storing information and instructions.

The communication interface 450 enables the computer system 400 to communicate with one or more networks 480 (e.g., cellular network) through use of the network link (wireless or wired). Using the network link, the computer system 400 can communicate with one or more computing devices, one or more servers, and/or one or more databases. In various examples, the computer system 400 can further include or communicate with one or more wireless signal sensors 460 and/or one or more wireless signal generators 470 (e.g., a Wi-Fi signal generator) to perform the operations described throughout the present disclosure. In accordance with examples provided herein, the memory 420 can store a profile database 428 comprising profiles of one or more individuals. In various examples, the executable instructions stored in the memory 420 can include monitoring instructions 422, alerting instructions 424, and drone deploy instructions 426.

By way of example, the instructions and data stored in the memory 420 can be executed by the processor 410 to implement the functions of an example signal processing device of FIG. 1. In various examples, the processor 410 can execute the monitoring instructions 422 to process wireless signal data to detect events, verify whether an individual is present, and determine whether an emergency event has occurred. The processors 410 can further execute the alerting instructions 424 to generate and transmit alerts upon detecting an emergency event, as described above. The processors 410 can further execute the drone deploy instructions, to transmit a deployment command to a local drone to capture images of a detected emergency event, as described in detail above.

Examples described herein are related to the use of the computer system 400 for implementing the techniques described herein. According to one example, those techniques are performed by the computer system 400 in response to the processor 410 executing one or more sequences of one or more instructions contained in the main memory 420. Such instructions may be read into the main memory 420 from another machine-readable medium, such as the storage device 440. Execution of the sequences of instructions contained in the main memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A signal processing device comprising:
one or more processors; and
a memory storing instructions that, when executed by the one or more processors, cause the signal processing device to:
determine a wireless sensor signature of an individual within a sensory environment of the signal processing device, the wireless sensor signature corresponding to reflected wireless signals from the individual;
based on reflected wireless signals from the individual, detect an emergency event at an emergency location within the sensory environment; and
in response to detecting the emergency event, transmit, over a wireless network, a deploy command to a drone that includes a camera, the deploy command indicating the emergency location and including an imaging command to capture live images of the emergency event.

2. The signal processing device of claim 1, wherein the executed instructions further cause the signal processing device to:
initiate wireless communications with a third-party entity to provide the third-party entity with an indication of the emergency event.

3. The signal processing device of claim 2, wherein the third-party entity comprises one of an emergency contact of the individual or an emergency service.

4. The signal processing device of claim 2, wherein the imaging command includes an instruction to the drone to record the live images of the emergency event.

5. The signal processing device of claim 4, wherein the executed instructions further cause the signal processing device to:
receive a recording of the live images of the emergency event from the indoor drone over the wireless network; and
transmit the recording of the live images to the third-party entity via the wireless communications.

6. The signal processing device of claim 1, wherein the imaging command further causes the drone to transmit a live feed of the live images to the signal processing device over the wireless network.

7. The signal processing device of claim 6, wherein the executed instructions further cause the signal processing device to:
initiate wireless communications with a third-party entity to provide an indication of the emergency event, the third-party entity comprising one of an emergency contact of the individual or an emergency service; and
transmit, via the wireless communications, the live feed to the third-party entity to provide the third-party entity with the live images of the emergency event.

8. The signal processing device of claim 1, wherein the reflected wireless signals originate from one or more wireless signal sources external to the signal processing device.

9. The signal processing device of claim 8, wherein the one or more wireless signal sources external to the signal processing device comprise one or more smartphones, smart home devices, or a wireless router.

10. The signal processing device of claim 8, wherein the reflected signals comprise Wi-Fi signals.

11. A non-transitory computer readable medium storing instructions that, when executed by one or more processors of a signal processing device, cause the signal processing device to:
determine a wireless sensor signature of an individual within a sensory environment of the signal processing device, the wireless sensor signature corresponding to reflected wireless signals from the individual;
based on reflected wireless signals from the individual, detect an emergency event at an emergency location within the sensory environment; and
in response to detecting the emergency event, transmit, over a wireless network, a deploy command to a drone that includes a camera, the deploy command indicating the emergency location and including an imaging command to capture live images of the emergency event.

12. The non-transitory computer readable medium of claim 11, wherein the executed instructions further cause the signal processing device to:
initiate wireless communications with a third-party entity to provide the third-party entity with an indication of the emergency event.

13. The non-transitory computer readable medium of claim 12, wherein the third-party entity comprises one of an emergency contact of the individual or an emergency service.

14. The non-transitory computer readable medium of claim 12, wherein the imaging command includes an instruction to the drone to record the live images of the emergency event.

15. The non-transitory computer readable medium of claim 14, wherein the executed instructions further cause the signal processing device to:
receive a recording of the live images of the emergency event from the indoor drone over the wireless network; and
transmit the recording of the live images to the third-party entity via the wireless communications.

16. The non-transitory computer readable medium of claim 11, wherein the imaging command further causes the drone to transmit a live feed of the live images to the signal processing device over the wireless network.

17. The non-transitory computer readable medium of claim 16, wherein the executed instructions further cause the signal processing device to:
initiate wireless communications with a third-party entity to provide an indication of the emergency event, the third-party entity comprising one of an emergency contact of the individual or an emergency service; and
transmit, via the wireless communications, the live feed to the third-party entity to provide the third-party entity with the live images of the emergency event.

18. The non-transitory computer readable medium of claim 11, wherein the reflected wireless signals originate from one or more wireless signal sources external to the signal processing device.

19. The non-transitory computer readable medium of claim 18, wherein the one or more wireless signal sources external to the signal processing device comprise one or more smartphones, smart home devices, or a wireless router.

20. A computer-implemented method of detecting emergency events, the method being performed by one or more processors of a signal processing device and comprising:
determining a wireless sensor signature of an individual within a sensory environment of the signal processing device, the wireless sensor signature corresponding to reflected wireless signals from the individual;
based on reflected wireless signals from the individual, detecting an emergency event at an emergency location within the sensory environment; and
in response to detecting the emergency event, transmitting, over a wireless network, a deploy command to a drone that includes a camera, the deploy command indicating the emergency location and including an imaging command to capture live images of the emergency event.
